(19) United States
(12) Patent Application Publication
(10) Pub. No.: US 2022/0369883 A1
(43) Pub. Date: Nov. 24, 2022

(54) POWER SHARING VACUUM CLEANER ASSEMBLY

(71) Applicant: Zenith Technologies, LLC, Fort Lauderdale, FL (US)

(72) Inventor: Mark D. BOSSES, Boca Raton, FL (US)

(21) Appl. No.: 17/540,180

(22) Filed: Dec. 1, 2021

Related U.S. Application Data
(60) Provisional application No. 63/192,504, filed on May 24, 2021.

(51) Int. Cl. A47L 9/28; A47L 5/24; A47L 9/24; A47L 9/04; A47L 5/22; H01M 50/204; H01M 50/247; H01M 50/509

(52) U.S. Cl. CPC A47L 9/2884; A47L 5/24; A47L 9/248; A47L 9/2842; A47L 9/2878; A47L 9/0411; A47L 5/225; H01M 50/204; H01M 50/247; H01M 50/509; H01M 2220/30

(57) ABSTRACT

A vacuum cleaner assembly includes a vacuum body, a suction wand removably connected to the vacuum body, and an accessory removably connected to the suction wand. A suction motor is disposed in the vacuum body and is configured to create flow through a suction path. An accessory motor is disposed in the accessory. A first power source is configured to supply power to the suction motor and to the accessory motor. A second power source is configured to supply power to the suction motor and to the accessory motor when the first power source falls below a predetermined charge level.

### CROSS REFERENCE TO RELATED APPLICATIONS

This application claims the benefit under 35 U.S.C. § 119(e) of U.S. Provisional Application No. 63/192,504, filed May 24, 2021. The entire disclosure of U.S. Provisional Application No. 63/192,504 is hereby incorporated herein by reference.

### BACKGROUND

### Field of the Invention

This invention generally relates to a power sharing vacuum cleaner assembly. More specifically, the present invention relates to a vacuum cleaner assembly having a first power source configured to supply power and a second power source configure to supply power when the first power source falls below a predetermined charge level.

### Background Information

A conventional cordless vacuum cleaner has a single power source that creates a suction path through a vacuum body of the vacuum cleaner. A plurality of accessories can be removably connectable to a vacuum body of the vacuum cleaner to provide a wide range of cleaning options. Some accessories, such as a powerhead, require power to operate. The charge level of the single power source of the vacuum cleaner is more quickly depleted when creating the suction path through the vacuum body and powering an accessory connected to the vacuum body.

### SUMMARY

Generally, the present disclosure is directed to various features of a power sharing vacuum cleaner assembly.

In view of the state of the know technology and in accordance with a first aspect of the present disclosure, a vacuum cleaner assembly includes a vacuum body, a suction wand removably connected to the vacuum body, and an accessory removably connected to the suction wand. A suction motor is disposed in the vacuum body and is configured to create flow through a suction path. An accessory motor is disposed in the accessory. A first power source is configured to supply power to the suction motor and to the accessory motor. A second power source is configured to supply power to the suction motor and to the accessory motor when the first power source falls below a predetermined charge level.

Another aspect of the present invention is to provide a vacuum cleaner assembly including a vacuum body, a suction wand removably connected to the vacuum body, and an accessory removably connected to the suction wand. The accessory is configured to be directly connected to the vacuum body when the suction wand is detached from the vacuum body. A suction motor is disposed in the vacuum body and is configured to create flow through a suction path. An accessory motor is disposed in the accessory. An electronic controller is disposed in the vacuum body. A first power source is connected to an outer surface of the suction wand or disposed in the accessory. The first power source is electrically connected to the electronic controller. A second power source is disposed in the vacuum body and electrically connected to the electronic controller. The first power source is configured to supply power to the suction motor and to the accessory motor. The second power source is configured to supply power to the suction motor and to the accessory motor when the first power source falls below a predetermined charge level.

Also, other objects, features, aspects and advantages of the disclosed power sharing vacuum cleaner assembly will become apparent to those skilled in the art from the following detailed description, which, taken in conjunction with the annexed drawings, discloses several embodiments of a power sharing vacuum cleaner assembly.

### BRIEF DESCRIPTION OF THE DRAWINGS

Referring now to the attached drawings which form a part of this original disclosure:

FIG. 1 is an exploded assembly view of a power sharing vacuum cleaner assembly in accordance with an exemplary embodiment of the present invention;

FIG. 2 is a perspective view of a powerhead configured to be removably connected to a vacuum body of the vacuum cleaner assembly of FIG. 1;

FIG. 3 is a perspective view of an assembled vacuum cleaner assembly of FIG. 1;

FIG. 4 is a perspective view of the assembled vacuum cleaner assembly of FIG. 1 illustrating power sharing of first and second power sources;

FIG. 5 is a front elevational view of a control panel disposed on the vacuum body of the vacuum cleaner assembly of FIG. 4;

FIG. 6 is a diagram of an electrical path in the vacuum cleaner assembly of FIG. 3;

FIG. 7 is a perspective view of a vacuum cleaner assembly connected to a charging stand in accordance with another exemplary embodiment of the present invention;

FIG. 8 is an enlarged perspective view of the vacuum cleaner assembly and charging stand of FIG. 7 illustrating a charging receptacle for a battery;

FIG. 9 is an exploded assembly view of the vacuum cleaner assembly and the charging stand of FIG. 7; and

FIG. 10A is a perspective view of a vacuum cleaner assembly according to another exemplary embodiment of the present invention in which the vacuum cleaner assembly includes a first power source and a second power source;

FIG. 10B is a perspective view of the vacuum cleaner assembly of FIG. 10A in which the first power source includes fourteen battery cells;

FIG. 11 is an electrical configuration of the first power source of the vacuum cleaner assembly of FIG. 10;

FIG. 12 is an electrical configuration of the second power source of the vacuum cleaner assembly of FIG. 10;

FIG. 13 is a perspective view of the vacuum cleaner assembly of FIG. 10A in which a suction motor and an accessory motor are powered by a first power source;

FIG. 14 is a perspective view of the vacuum cleaner assembly of FIG. 10A in which a suction motor and an accessory motor are powered by a second power source;

FIG. 15 is a perspective view of the vacuum cleaner assembly of FIG. 10A in which a suction wand is removed and a suction motor and an accessory motor are powered by a second power source;

FIG. 16 is a perspective view of the vacuum cleaner assembly of FIG. 10A in which a suction wand and an accessory are removed and a suction motor is powered by a first power source;

FIG. 17 is a perspective view of the vacuum cleaner assembly of FIG. 10A in which a first power source is disposed in an accessory; and

FIG. 18 is a perspective view of the vacuum cleaner assembly of FIG. 10A in which a first power source is disposed in the suction wand and the accessory and a second power source is disposed in the vacuum body.

Throughout the drawing figures, like reference numerals will he understood to refer to like parts, components and structures.

### DETAILED DESCRIPTION OF EXEMPLARY EMBODIMENTS

Selected exemplary embodiments will now he explained with reference to the drawings. It will be apparent to those skilled in the art from this disclosure that the following descriptions of the exemplary embodiments are provided for illustration only and not for the purpose of limiting the invention as defined by the appended claims and their equivalents.

As shown in FIGS. 1-5, a power sharing vacuum cleaner assembly 10 in accordance with an exemplary embodiment of the present invention includes a vacuum body 12 and an accessory 14. The accessory 14 is removably connected to the vacuum body 12. The vacuum cleaner assembly 10 can be any suitable type of vacuum cleaner, such as, but not limited to, a cordless stick vacuum cleaner. The various components and interactions of the vacuum cleaner assembly 10 would be understood by one of ordinary skill in the art.

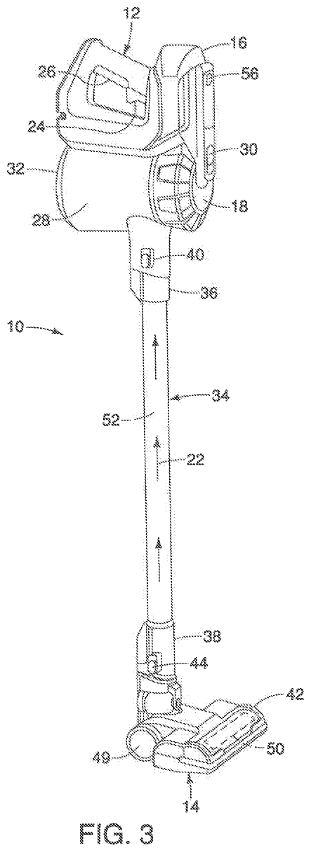

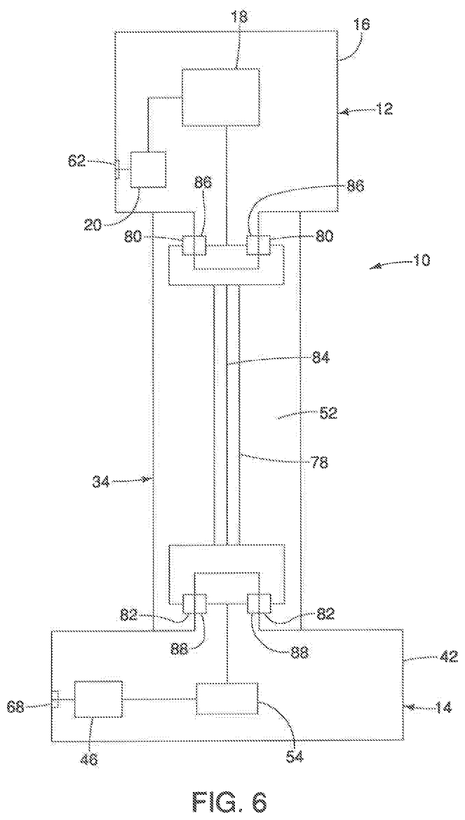

The vacuum body 12 includes a housing 16 in which a suction motor 18 and a first power source 20 are disposed, as shown in FIGS. 1 and 6. The first power source 20. such as a plurality of rechargeable batteries or a rechargeable battery pack, is electrically connected to and powers the motor 18, which creates a suction flow path 22, as shown in FIG. 3. A power button 24 disposed on the housing 16 turns on and off the power supply of the first power source 20 to the motor 18. The housing 16 includes a gripping portion 26 to facilitate handling the vacuum cleaner assembly 10. The first power source 20 is preferably removably disposed in the vacuum body 12.

The housing 16 further includes a dust bin 28 configured to receive dirt and. other debris collected during operation of the vacuum cleaner assembly 10. Alternatively, the dust bin 28 can be removably connected to the housing 16. The suction path 22 flows into and through the dust bin 28, thereby trapping dust, dirt and other debris carried through the suction path 22 inside the dust bin 28. A release button 30 disposed on the housing 16 can be operated to open a cover 32 of the bust bin 28 to discard the contents of the dust bin 28. Alternatively, the dust bin 28 can be removed from the housing 16 to discard the contents thereof, and the dust bin can then be reconnected to the housing.

The suction motor 18 of the vacuum cleaner assembly 10 creates flow through the suction path 22, as shown in FIG. 3. The suction path 22 extends from a suction inlet of the accessory 14 to the dust bin 28. The suction path 22 flows into and through the dust bin 28, thereby trapping dust, dirt and other debris carried through the suction path 22 inside the dust bin 28. The suction path 22 exits the housing 16 through vents disposed therein.

A suction wand 34 is removably connected to the vacuum body 12. The suction wand 34 has a first end 36 and a second end 38. The first end 36 of the suction wand 34 is connected to the vacuum body 12. The suction wand 34 is removably connected to the vacuum body 12 in any suitable manner, such as a snap fit connection, that facilitates connecting the suction wand 34 to and removing the suction wand 34 from the vacuum body 12. A release button 40 on the vacuum body 12 releases the connection between the suction wand 34 and the vacuum body 12 such that the suction wand 34 can be removed from the vacuum body 12. Alternatively, the release button 40 can be disposed on the suction wand 34. The accessory 14 can be received by the vacuum body 16 when the suction wand 34 is not connected to the vacuum body 16.

A second end 38 of the suction wand 34 is configured to receive the accessory 14, such as a powerhead 42. The accessory 14 is removably connected to the suction wand 34 in any suitable manner, such as a snap fit connection, that facilitates connecting the accessory 14 to and removing the accessory 14 from the suction wand 34. A release button 44 on the suction wand 34 releases the connection between the accessory 14 and the suction wand 34 such that the accessory 14 can be removed. Alternatively, the release button 44 can be disposed on the accessory 14.

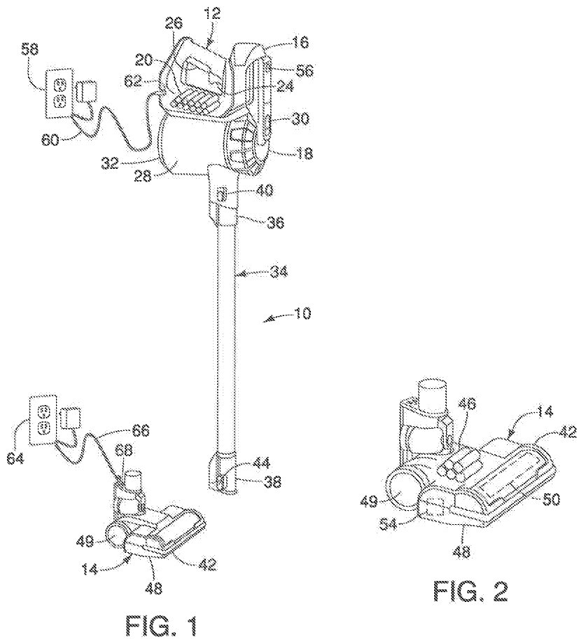

The accessory 14, such as the powerhead 42, is removably connected to the suction wand 34 to provide alternative cleaning options, as shown in FIGS. 1 and 3. Alternatively, the accessory 14 can be directly removably connected to the vacuum body 12. The accessory 14 has a second power source 46, as shown in FIG. 2, configured to supply power to the accessory 14. The accessory 14 is shown as a powerhead 42, although the accessory 14 can be any suitable power tool having an internal power source.

As shown in FIG. 2, the powerhead 42 includes the second power source 46 disposed within a housing 48. The second power source 42 is preferably a plurality of rechargeable batteries or a rechargeable battery pack, although any suitable power source can be used. The second power source 46 is preferably removably disposed in the accessory 14.

The powerhead 42 includes a plurality of wheels 49 rotatably connected to the housing 48 to facilitate pushing and pulling the vacuum cleaner assembly 10 during operation. A surface agitator 50, such as a brush roll, is movably disposed in the housing 48. A suction inlet is disposed in a bottom surface of the housing 48 in association with the surface agitator 50. The suction path 22 extends from the suction inlet in the bottom surface of the housing 48, through a passage 52 in the suction wand 34 to the dust bin 28, as shown in FIG. 3.

A motor 54 is disposed in the housing 48 of the powerhead 42, as shown in FIGS. 2 and 6. The motor 54 is electrically connected to the second power source 46. The motor 54 drives the surface agitator 50. The motor 54 is configured to be powered by the second power source 46. A power button 56 disposed on the vacuum body housing 16 turns on and off the supply of power from the second power source 46 to the powerhead motor 54.

When the powerhead 42 is connected to the second end 38 of the suction wand 34, the suction path 22 extends from the suction inlet in the housing 48 of the powerhead 42, through the suction wand 34, through the housing 16 of the vacuum body 12, and to the dust bin 28, as shown in FIG. 2. The suction path 22 continues through the dust bin 28 back into the vacuum body housing 16. The air flowing through the vacuum body housing 16 is then vented to the atmosphere through vents in the vacuum body housing 16. The dust bin 28 is configured to trap dust and other debris carried though the suction path 22 to the dust bin 28.

The first power source 20 is configured to generate flow through the suction path 22. The first power source 20 is disposed in the vacuum body housing 16 and is configured to be connected to an external power supply 58, such as an electrical outlet, to charge the first power source 20, as shown in FIG. 1. A power cord 60 is connected between a port 62 in the vacuum body housing 16 and the external power supply 58 to supply power from the external power supply 58 through the power cord 60 to charge the first power source 20, as shown in FIGS. 1 and 6. The port 62 is electrically connected to the first power source 20. The power cord 60 is removed from the port 62 and the external power supply 58 when the first power source is charged to a desired level. An indicator can be disposed on the vacuum body housing 16 to indicate when the first power source 20 is fully charged.

The second power source 46 is configured to power the powerhead 42. The second power source 46 is disposed in the powerhead housing 48 and is configured to be connected to an external power supply 64, such as an electrical outlet, to charge the second power source 46, as shown in FIG. 1. A power cord 66 is connected between a port 68 in the powerhead housing 52 and the external power supply 64 to supply power from the external power supply 64 through the power cord 66 to charge the second power source 46. The port 68 is electrically connected to the second power source 46. The power cord 66 is removed from the port 68 and the external power supply 64 when the second power source 46 is charged to a desired level. An indicator can be disposed on the powerhead housing 42. to indicate when the second power source 46 is fully charged. The power cords 60 and 66 allow the first and second power sources 20 and 46 to be independently charged. Alternatively, a single power cord can be connected to one of the ports 62 and 68 to simultaneously charge both the first and second power sources 20 and 46 when the accessory 14 is connected to the vacuum body 12.

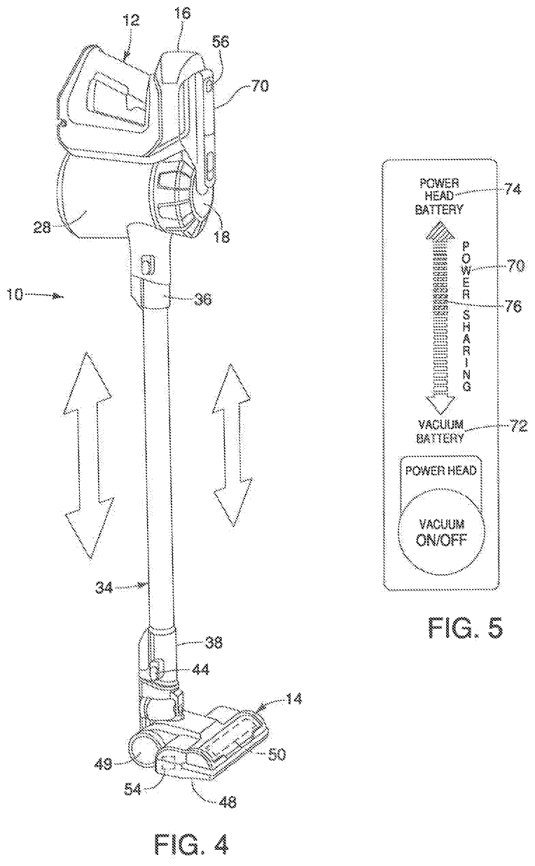

By disposing the second power source 46 in the accessory 14, the weight of the vacuum cleaner assembly 10 is more evenly distributed. The weight of the second power source 46 disposed in the accessory 14 is proximal to the floor, such that the weight of the second power source 46 is spaced from the first power source 20 which is disposed in the body housing 16 spaced farther from the floor than the second power source 46. The second power source 46 is spaced from the first power source 20 by at least a length of the suction wand 34, as shown in FIGS. 4 and 6. In other words, the suction wand 34 is disposed between the first power source 20 and the second power source 46.

An electrical conduit 78 extends through the passage 52 in the suction wand 34, such that mechanically connecting the suction wand 34 to the vacuum body 12 and to the accessory 14 also electrically connects the vacuum body 12 and the accessory 14. The first and second ends 36 and 38 of the suction wand 34 have electrical contacts 80 and 82, respectively, electrically connected to electrical wiring 84 extending through the conduit 78. The electrical contacts 80 and 82 mate with corresponding electrical contacts 86 and 88 disposed in the vacuum body housing 16 and the powerhead housing 48, respectively. The electrical contacts 86 and 88 disposed in the vacuum body housing 16 and the powerhead housing 48 are electrically connected to the first and second power sources 20 and 46, respectively, An electrical path extends between the first power source 20 and the second power source 46 such that electrical power can be shared therebetween. The electrical path extends from the first power source 20 to the engaged electrical contacts 86 and 80 in the vacuum body housing 16 and the first end 36 of the suction wand 34, through the wiring 84 disposed in the conduit 78 in the suction wand 34, to the engaged electrical contacts 82 and 88 in the second end 38 of the suction wand 34 and the powerhead housing 48, and to the second power source 54.

During operation of the vacuum cleaner assembly 10, the first power source 20 powers the suction motor 18 and the second power source 46 powers the powerhead motor 54. When a power level of the second power source 46 falls below a second predetermined level, electrical power is supplied from the first power source 20 through the electrical path to the second power source 46 to maintain operation of the powerhead motor 54. thereby extending the operation time of the vacuum cleaner assembly 10. When a power level of the first power source 20 falls below a first predetermined level, electrical power is supplied from the second power source 46 through the electrical path to the first power source 20 to maintain operation of the suction motor 18, thereby extending the operation time of the vacuum cleaner assembly 10. As shown in FIG. 4, power can be shared in either direction between the first and second power 20 and 46. The first and second predetermined power levels can be any suitable power level, such as sharing being initiated when one of the power sources is at or below five percent of the charge remaining. Alternatively, the first and second predetermined charge levels are different such that one power source receives power at a different remaining charge than the other power source.

A controller is disposed in the vacuum body housing 16 and is electrically connected to the electrical path. The controller monitors the charge levels of the first and second power sources 20 and 46. Upon detecting that one of the first and second power sources 20 and 46 falls below a second predetermined level, the controller causes electrical power to be supplied from the other of the first and second power sources 20 and 46 to the power source detected to be below the predetermined level. The first and second predetermined levels can be the same, or can be different.

A display panel 70 is disposed on the vacuum body housing 16, as shown in FIGS. 4 and 5, The display panel 70 includes an indication 72 for the vacuum battery at one end and an indication 74 for the powerhead battery at an opposite end. A power sharing meter 76 extends between the vacuum battery indication 72 and the powerhead battery indication 74 and is illuminated to indicate when electrical power is shared between the first and second power sources 20 and 46 and to indicate in which direction electrical power is being shared. As shown in FIG. 5, electrical power is being shared from the powerhead battery, or the second power source, to the vacuum battery, or the first power source. Sharing electrical power between the first and second power sources 20 and 46 prolongs the operation time of the vacuum cleaner assembly 10, as electrical power from a sufficiently charged power source can be shared with a depleted power source.

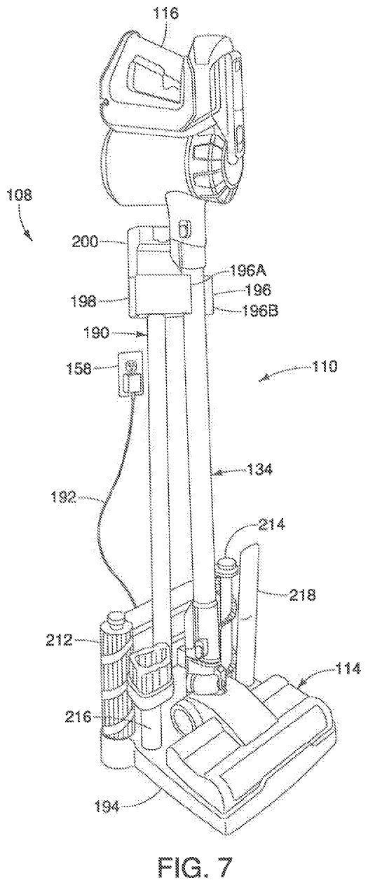

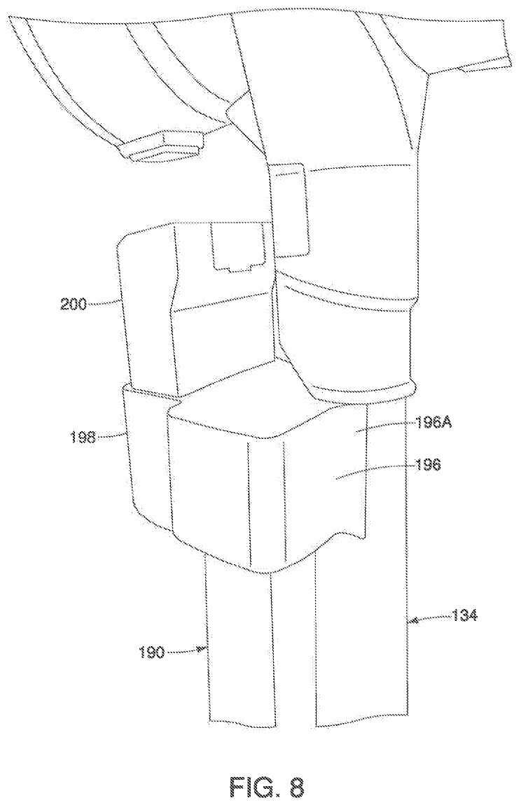

As shown in FIGS. 7-9, a vacuum cleaner assembly 110 in accordance with another illustrated exemplary embodiment of the present invention is substantially similar to the vacuum cleaner assembly 10 of the exemplary embodiment illustrated in FIGS. 1 to 6 except for the differences described below. Similar parts are identified with similar reference numerals, except increased by 100 (i.e., 1xx, accordingly).

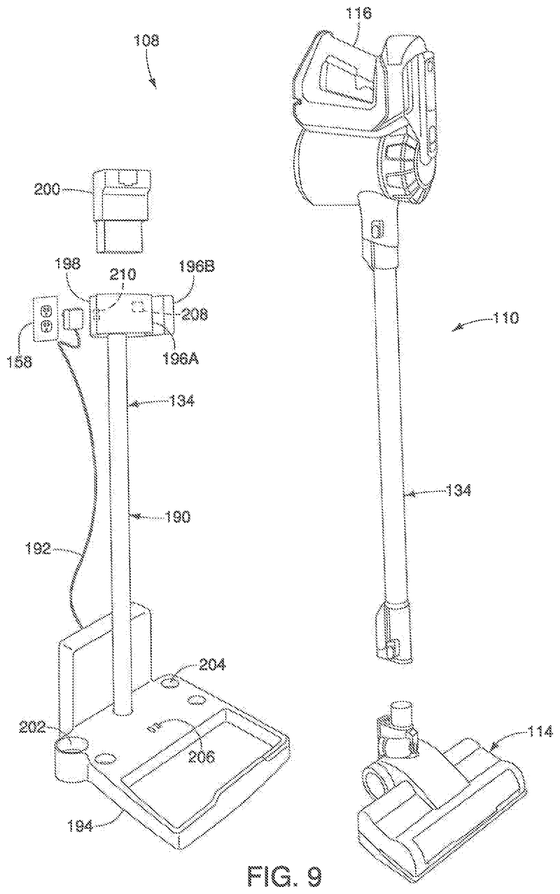

A vacuum cleaner charging assembly 108, as shown in FIGS. 7 and 9. includes the vacuum cleaner assembly 110 and a charging stand 190. The first and second power sources of the vacuum cleaner assembly 110 are charged through the charging stand 190, as shown in FIGS. 7-9. The stand 190 includes a power cord 192 removably connectable to the external power supply 158 to supply electrical power from the external power supply 158 to the stand 190. The stand 190 includes a base 194 for removably receiving the powerhead 114, a suction wand receiver 196 for removably receiving the suction wand 134, and a battery receptacle 198 for removably receiving a battery pack 200 (i.e., a third power source).

The base 194 of the stand 190 removably receives the powerhead 114 of the vacuum cleaner assembly 110, as shown in FIGS. 7 and 9. The power cord 192 extends from the base 194 and is removably connectable to the external power source 158 to supply power to the stand 190. The base 194 includes a plurality of openings 202 and 204 to removably receive a plurality of accessories removably connectable to the vacuum cleaner assembly 110. As shown in FIG. 9, the openings 202 and 204 can be different sizes to accommodate various sized accessories. The accessories can include, but are not limited to, brush rolls 212 and 214, dust brushes 216, and crevice tools 218.

The base 194 includes an electrical contact 206 that is engaged by a corresponding electrical contact on the powerhead 114 to charge the second power source 46 (FIG. 6) disposed in the powerhead 114 when the stand 190 is connected to the external power supply 158, as shown in FIG. 7. The electrical contact 206 can be disposed in any suitable position of the base 194 that is contacted by the powerhead 114 when the powerhead 114 is received by the base 194 of the stand 190.

The suction wand receiver 196 removably receives the suction wand 134 of the vacuum cleaner assembly 110, as shown in FIGS. 7-9. The suction wand receiver 196, as shown in FIG. 7, includes a pair of outwardly extending flexible tabs 196A and 196B. The tabs 196A and 196B are spaced apart by a distance less than the diameter of the suction wand 134, such that the tabs 196A and 196B flex outwardly to receive the suction wand 134 of the vacuum cleaner assembly 110. The tabs 196A and 196B return to their original position to securely retain the suction wand 134 to the suction wand receiver 196 of the base 190.

The suction wand receiver 196 includes an electrical contact 208 that is engaged by a corresponding electrical contact on the suction wand 134 to charge the first power source 20 disposed in the housing 16 (FIG. 1) when the stand 190 is connected to the external power supply 158, as shown in FIG. 7, The electrical contact 208 can be disposed in any suitable position of the suction wand receiver 196 that is contacted by the suction wand 134 when the suction wand 134 is received by the suction wand receiver 196 of the stand 190.

The battery receptacle 198 has a vertically oriented opening for receiving a battery pack 200, as shown in FIGS. 7-9. The battery receptacle 198 includes an electrical contact 210 that is engaged by a corresponding electrical contact on the battery pack 200 to charge the battery pack 200 when the stand 190 is connected to the external power supply 158, as shown in FIG. 7. The electrical contact 210 can be disposed in any suitable position of the battery receptacle 198 that is contacted by the battery pack 200 when the battery pack 200 is received by the battery receptacle 198 of the stand 190. Accordingly, the battery pack 200 can replace one of the first and second power sources 20 and 46 connected to the housing 116 or the powerhead 114 of the vacuum cleaner assembly 110. The first and second power sources 20 and 46 can be identical battery packs, such that the battery pack 200 can be used to replace either the first or second power sources when depleted. Alternatively, the first and second power sources 20 and 46 can be different, and the third power source 200 can be identical to one of the first and second power sources 20 and 46 to replace that power source when depleted. Although the charging stand 190 is shown with one battery receptacle 198, the charging stand 198 can include additional battery receptacles such that a plurality of battery packs can be simultaneously charged and stored.

Each of the electrical contacts 206, 208 and 210 is electrically connected to the power cord 192. Electrical power is supplied to each of the electrical contacts 206, 208 and 210 when the power cord 192 of the stand 190 is connected to the external power source 158, as shown in FIG. 7, The stand 190 simultaneously receives the suction wand 134, the powerhead 114 and the battery pack 200 such that the suction wand 134, the powerhead 114 and the battery pack 200 can be simultaneously charged. The battery pack, or the third power source), 200 can be charged when the vacuum cleaner assembly 110 is in operation and not connected to the charging stand 190,

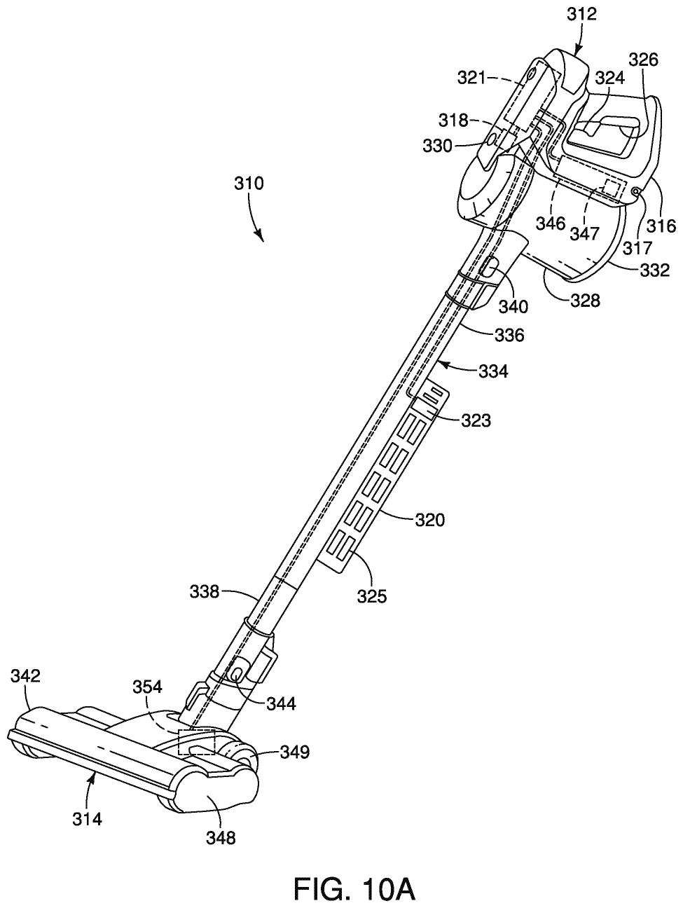

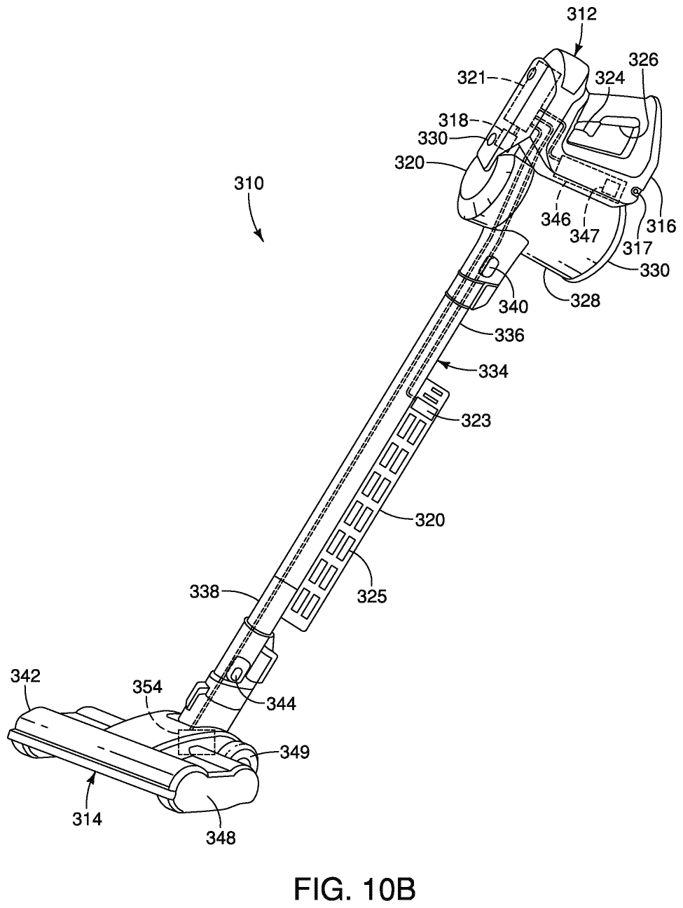

As shown in FIGS. 10A-16, a vacuum cleaner assembly 310 in accordance with another illustrated exemplary embodiment of the present invention is substantially similar to the vacuum cleaner assembly 10 of the exemplary embodiment illustrated in FIGS. 1 to 6 except for the differences described below. Similar parts are identified with similar reference numerals, except increased by 300 (i.e., 3xx, accordingly).

As shown in FIGS. 10A-16, the power sharing vacuum cleaner assembly 310 in accordance with an exemplary embodiment of the present invention includes a vacuum body 312, a suction wand 334, and an accessory 314. The suction wand 334 is removably connected to the vacuum body 312. The accessory 334 is removably connected to the suction wand 334. The suction wand 334 is removable from the vacuum body 312, such that the accessory 314, or a different accessory, can be removably connected to the vacuum body 312. The vacuum cleaner assembly 310 can be any suitable type of vacuum cleaner, such as, but not limited to, a cordless stick vacuum cleaner. The various components and interactions of the vacuum cleaner assembly 310 would be understood by one of ordinary skill in the art.

The vacuum body 312 includes a housing 316 in which a suction motor 318 and a second power source 346 are disposed, as shown in FIGS. 10A, 10B and 13-16. The second power source 346, such as a plurality of rechargeable batteries, is electrically connected to and powers the suction motor 318, which creates a suction flow path 22 (FIG. 3). A power button 324 disposed on the housing 316 turns on and off the power supply of the first and second power sources 320 and 346. The housing 316 includes a gripping portion 326 to facilitate handling the vacuum cleaner assembly 310. A charging port 317 is disposed in the housing 316 to facilitate receiving an electrical cord (FIG. 1) to charge the second power source 346. The other end of the electrical cord can be connected to an external power source, such as an electrical outlet, to supply power to charge the second power source.

The housing 316 further includes a dust bin 328 configured to receive dirt and other debris collected during operation of the vacuum cleaner assembly 310. Alternatively, the dust bin 328 can be removably connected to the housing 316. The suction path 22 (FIG. 3) flows into and through the dust bin 328, thereby trapping dust, dirt and other debris carried through the suction path 22 inside the dust bin 328. A release button 330 disposed on the housing 316 can be operated to open a cover 332 of the bust bin 328 to discard the contents of the dust bin 328. Alternatively, the dust bin 328 can be removed from the housing 316 to discard the contents thereof and the dust bin 328 can then be reconnected to the housing 316.

The suction motor 318 of the vacuum cleaner assembly 310 creates flow through the suction path 22 (FIG. 3). The suction path 22 extends from a suction inlet of the accessory 314 to the dust bin 328. The suction path 22 flows into and through the dust bin 328, thereby trapping dust, dirt and other debris carried through the suction path 22 inside the dust bin 328. The suction path 22 exits the housing 316 through vents disposed therein.

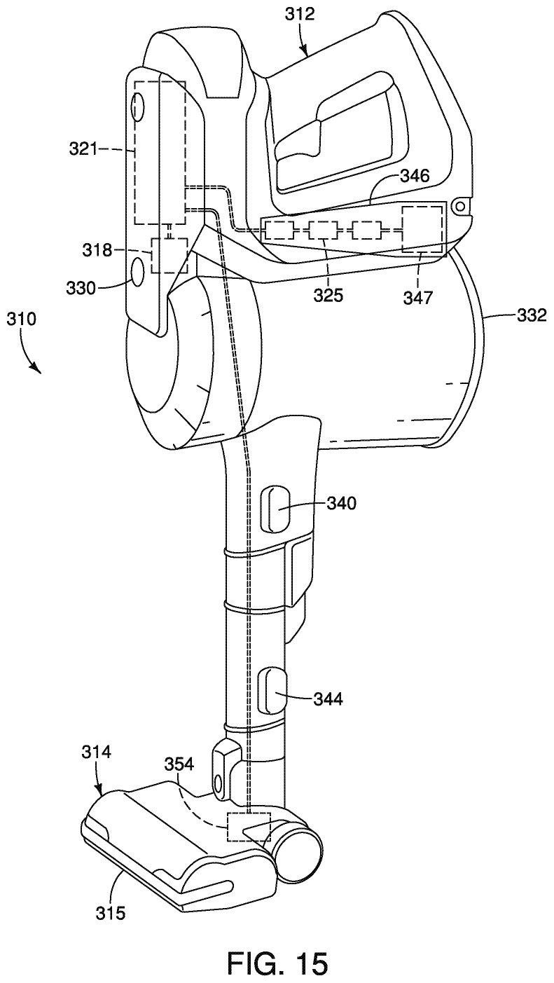

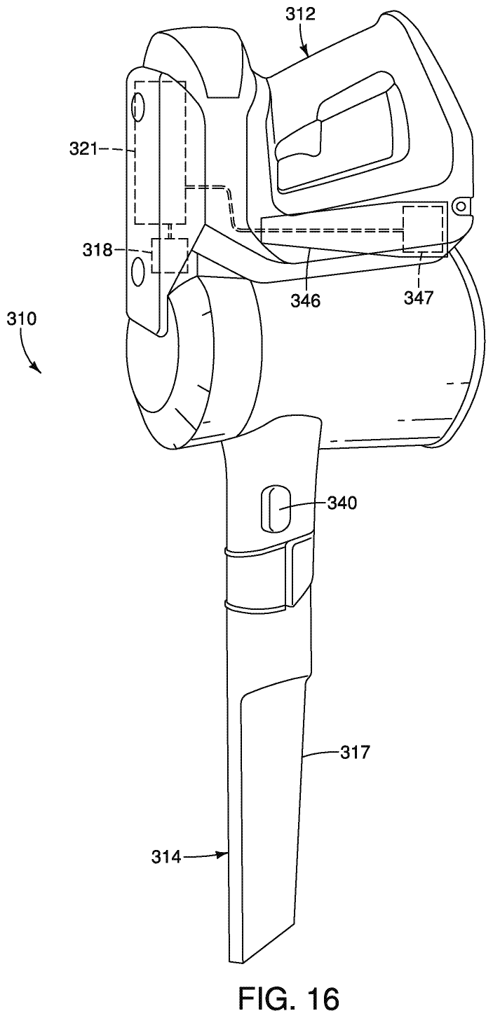

The suction wand 334 is removably connected to the vacuum body 312. The suction wand 334 has a first end 336 and a second end 338. The first end 336 of the suction wand 334 is removably connected to the vacuum body 312. The suction wand 334 is removably connected to the vacuum body 312 in any suitable manner, such as a snap fit connection, that facilitates connecting the suction wand 334 to and removing the suction wand 334 from the vacuum body 312. A release button 340 on the vacuum body 312 releases the connection between the suction wand 334 and the vacuum body 312 such that the suction wand 334 can be removed from the vacuum body 312. Alternatively, the release button 340 can be disposed on the suction wand 334. The accessory 314 can be removably received by the vacuum body 312 when the suction wand 334 is not connected to the vacuum body 312. As shown in FIGS. 15 and 16, different accessories can be removably connected to the vacuum body 312 when the suction wand 334 is removed. As shown in FIG. 15, a mini powerhead 315 is removably connected to the vacuum body 312. As shown in FIG. 16, a suction tool 317 is removably connected to the vacuum body 312. The release button 340 is depressed to remove the accessory connected to the vacuum body 312.

A second end 338 of the suction wand 334 is configured to receive the accessory 314, such as a powerhead 342. The accessory 314 is removably connected to the suction wand 34 in any suitable manner, such as a snap fit connection, that facilitates connecting the accessory 314 to and removing the accessory 314 from the suction wand 334. A release button 344 on the accessory 314 releases the connection between the accessory 314 and the suction wand 334 such that the accessory 314 can be removed. Alternatively, the release button 344 can be disposed on the suction wand 334.

The accessory 314, such as the powerhead 342, is removably connected to the suction wand 334 to provide alternative cleaning options, as shown in FIGS. 10A, 10B and 13-16, The accessory 314 is configured to be directly removably connected to the vacuum body 312 when the suction wand 334 is detached from the vacuum body 312, as shown in FIGS. 15 and 16.

The powerhead 342 includes a plurality of wheels 349 rotatably connected to a housing 348 to facilitate pushing and pulling the vacuum cleaner assembly 310 during operation. A surface agitator 50 (FIG. 3), such as a brush roll, is movably disposed in the housing 348. A suction inlet is disposed in a bottom surface of the housing 348 in association with the surface agitator. The suction path 22 (FIG. 3) extends from the suction inlet in the bottom surface of the housing 348, through a passage 52 (FIG. 3) in the suction wand 334 to the dust bin 328, as shown in FIGS. 3 and 10.

An accessory motor 354 is disposed in the accessory 314, as shown in FIG. 10. The accessory motor 354 drives the surface agitator 50 (FIG. 3). The accessory motor 354 is disposed in the housing 348 of the powerhead 342. In some exemplary embodiments, the accessory 314 includes an accessory motor 354, such as the powerhead illustrated in FIGS. 10, 13 and 14, and the mini-powerhead 315 illustrated in FIG. 15. In some exemplary embodiments, the accessory 314 does not include an accessory motor, such as the suction tool 317 illustrated in FIG. 16.

As shown in FIGS. 10A and 10B, a first power source 320 is connected to the suction wand 334. The first power source 320 is preferably connected to an outer surface of the suction wand 334. The first power source 320 is preferably a plurality of rechargeable battery cells or a battery pack including a plurality of rechargeable battery cells, although any suitable power source can be used. The first power source 320 includes an electronic controller 323, such as a conventional battery management system, that manages the state of the first power source.

The second power source 346 is connected to the vacuum body 312, as shown in FIGS. 10A and 10B. The second power source 346 is preferably disposed in the vacuum body 312. The second power source 346 is preferably a plurality of rechargeable battery cells or a battery pack including a plurality of rechargeable battery cells, although any suitable power source can be used. The second power source 346 includes an electronic controller 347, such as a conventional battery management system, that manages the state of the second power source.

The first power source 320 is configured to supply power to the suction motor 318 and to the accessory motor 354, as shown in FIGS. 10A and 10B. The second power source 346 is configured to supply power to the suction motor 318 and to the accessory motor 354 when a charge level of the first power source 320 falls below a predetermined charge level.

As shown in FIG. 10A, the first power source 320 includes ten battery cells 325. As shown in FIG. 10B, the first power source 320 includes fourteen battery cells 325.

An electronic controller 321, such as a printed circuit hoard assembly, is disposed in the housing 316 of the vacuum body 312, as shown in FIGS. 10A and 10B. The electronic controller 321 is electrically connected to the first power source 320 and to the second power source 346 to control operation thereof. The electronic controller 321 monitors the charge levels of the first and second power sources 320 and 346. Power from the first and second power sources 320 and 346 is supplied through the electronic controller 321.

A power cord 60 (FIG. 1) is connected between the charge port 317 in the vacuum body housing 316 and an external power supply 58 (FIG. 1) to supply power from the external power supply through the power cord to charge the first and second power sources 320 and 346. The charge port 317 is electrically connected to the first and second power sources 320 and 346. The power cord is removed from the charge port 317 and the external power supply when the first and second power sources 320 and 346 are charged to a desired level. Indicators can be disposed on the vacuum body housing 316 to indicate when the first and second power sources 320 and 346 are fully charged. The same indicators, or different indicators, indicate a current charge level of the first and second power sources 320 and 346.

During operation of the vacuum cleaner assembly 310, the first power source 320 powers the suction motor 318 and the accessory motor 354. When the charge level of the first power source 320 falls below a predetermined level, the electronic controller 321 switches the supply of power from the first power source 320 to the second power source 346. In other words, when the electronic controller 321 detects that the charge level of the first power source 320 falls below the predetermined charge level, the second power source 346 then supplies electrical power to the suction motor 318 and to the accessory motor 354, thereby extending the operation time of the vacuum cleaner assembly 310. The predetermined charge level can be any suitable charge level, such as between two and eighteen percent, inclusive, charge remaining (of the capacity of the power source). Preferably, the predetermined charge level is approximately five percent charge remaining.

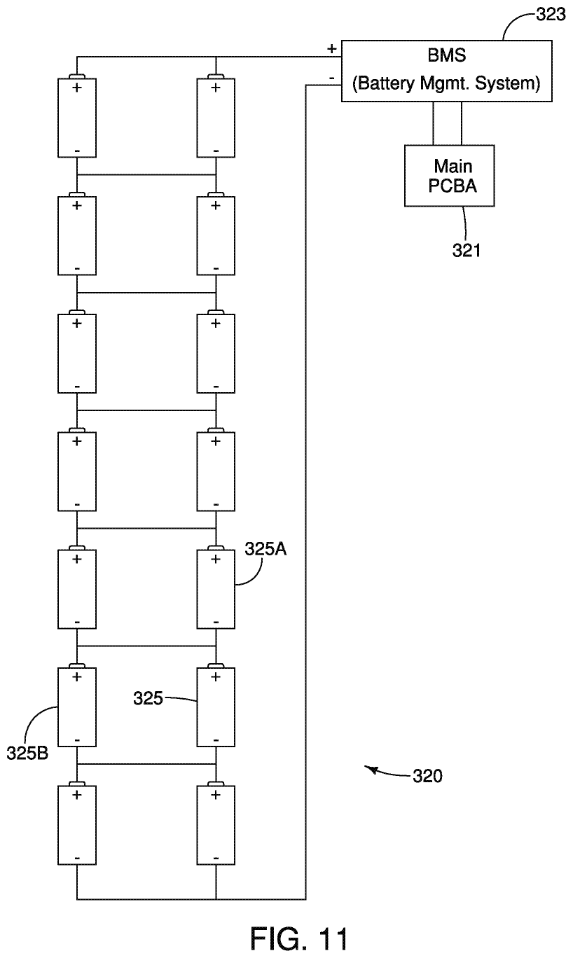

An exemplary configuration of the first power source 320 is illustrated in FIG. 11. The battery configuration shown in FIG. 11 is a series/parallel configuration. The configuration is a 7S2P battery configuration in which seven batteries are placed in series, and two batteries are placed in parallel. The first power source 320 is shown having fourteen battery cells 325, as shown in FIG. 10B, although the first power source 320 can have any suitable number of battery cells, such as ten battery cells 325 as shown in FIG. 10A. The first power source 320 is preferably configured such that a first plurality of battery cells 325A are connected in series, a second plurality of battery cells 325B are connected in series, and each of the second plurality of battery cells 325B is connected in parallel with one of the first plurality of battery cells 325A. A first set 325A of seven battery cells 325 are connected in series. A second set 325B of seven battery cells 325 are connected in series. This exemplary configuration provides seven battery cells 325 in series. The battery cell 325 can be conventional lithium ion battery cells providing 3.7 volts. The seven battery cells 325 connected in series provides a maximum voltage output of 25.9 volts. Providing each of the battery cells in the first set 325A of battery cells 325 in parallel to one of the battery cells in the second set of battery cells 325 provides the first power source 320 with double the lifetime of battery cells 325 by providing two sets of battery cells in parallel. In other words, the pathway through the seven battery cells in series is through one of the parallel battery cells in the first set 325A or one of the battery cells in the second set 325B to obtain seven battery cells in series for 25.9 volts.

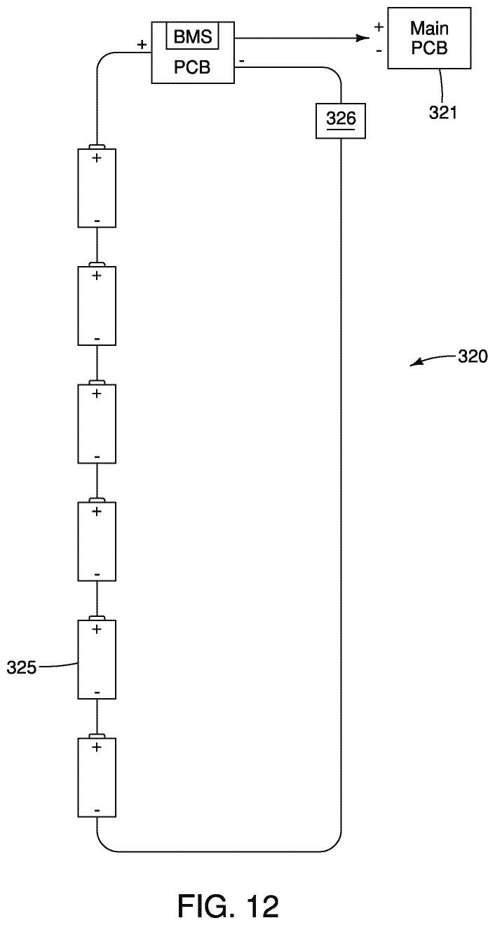

An exemplary configuration of the second power source 346 is illustrated in FIG. 12. The second power source 346 is shown having six battery cells 325, although the second power source 346 can have any suitable number of battery cells. The second power source 346 is preferably configured such that a plurality of battery cells 325 is connected in series. In other words, the six battery cells 325 in the second power source are connected in series. The battery cell 325 can be a conventional lithium ion battery cell providing 3.7 volts. The six battery cells 325 connected in series provides a maximum power voltage output of 22.2 volts. The maximum voltage output of the first power source 320 is preferably larger than the maximum voltage output of the second power source 346. Alternatively, the maximum voltage output of the first and second power sources 320 and 346 are substantially equal. Alternatively, the second power source 346 can be configured substantially similarly to the first power source 320. A first plurality of battery cells 325 can be connected in series, with a second plurality of battery cells connected in parallel with one another and in series with the first plurality of battery cells.

The suction motor 318 is preferably operable in first and second power settings. For example, the suction motor 318 can be operated in the first power setting, such as a normal mode, which requires a first voltage output, such as 22.2 volts. The suction motor 318 can be operated in the second power setting, such as a boost mode, which requires a second voltage output, such as 27.0 volts. The second power setting operates at a larger voltage output than the first power setting. The maximum voltage output of the second power source 346 is preferably less than the required voltage of the second power setting. In other words, the second power source 346 is configured to operate the suction motor 318 in only the first power setting.

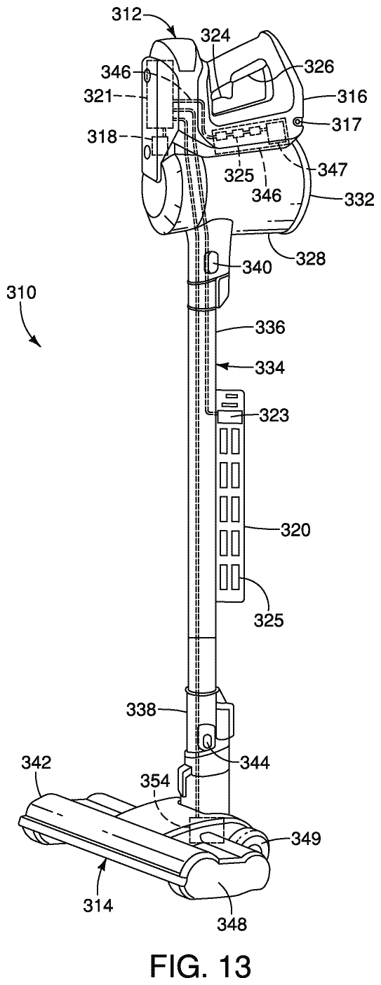

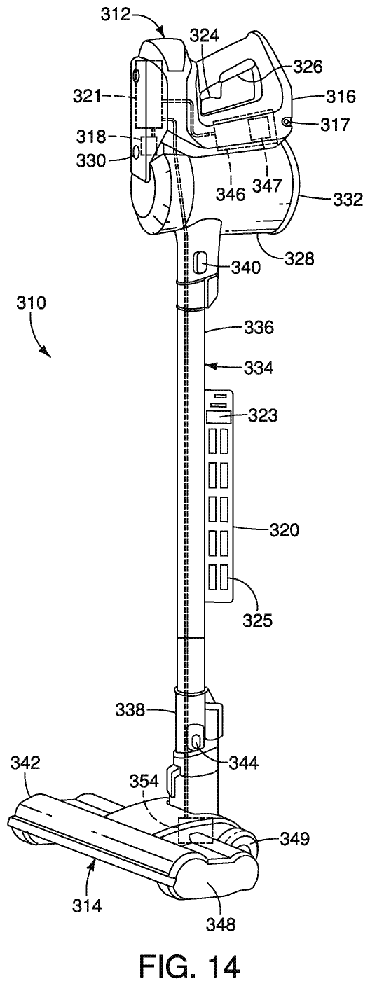

As shown in FIG. 10, the suction wand 334 is connected between the vacuum body 312 and the accessory 314. When the electronic controller 321 determines that the charge level of the first power source 320 is equal to or greater than the predetermined charge level, the first power source 320 supplies power to the suction motor 318 and to the accessory motor 354, as shown in FIG. 13. When the electronic controller determines that the charge level of the first power source 320 is less than the predetermined charge level, the electronic controller 321 switches the supply of power from the first power source 320 to the second power source 346, as shown in FIG. 14. In other words, when the electronic controller 321 determines that the charge level of the first power source 320 is less than the predetermined charge level, the second power source 320 supplies power to the suction motor 318 and to the accessory motor 354.

As shown in FIG. 15, the suction wand 334 is detached from the vacuum body 312 and the accessory 314. The accessory 314 is directly removably connected to the vacuum body 312. The accessory 314 includes an accessory motor 354. The illustrated accessory 314 is a mini-powerhead 315, although the accessory can be any suitable accessory including an accessory motor 354. In the absence of the first power source 320, the electronic controller 321 controls the second power source 346 to supply power to the suction motor 318 and to the accessory motor 354.

As shown in FIG. 16, the suction wand 334 is detached from the vacuum body 312 and the accessory 314. The accessory 314 is directly removably connected to the vacuum body 312. The accessory 314 does not include an accessory motor. The illustrated accessory 314 is a suction tool, although the accessory can be any suitable accessory without an accessory motor. In the absence of the first power source 320, the electronic controller 321 controls the second power source 346 to supply power to the suction motor 318.

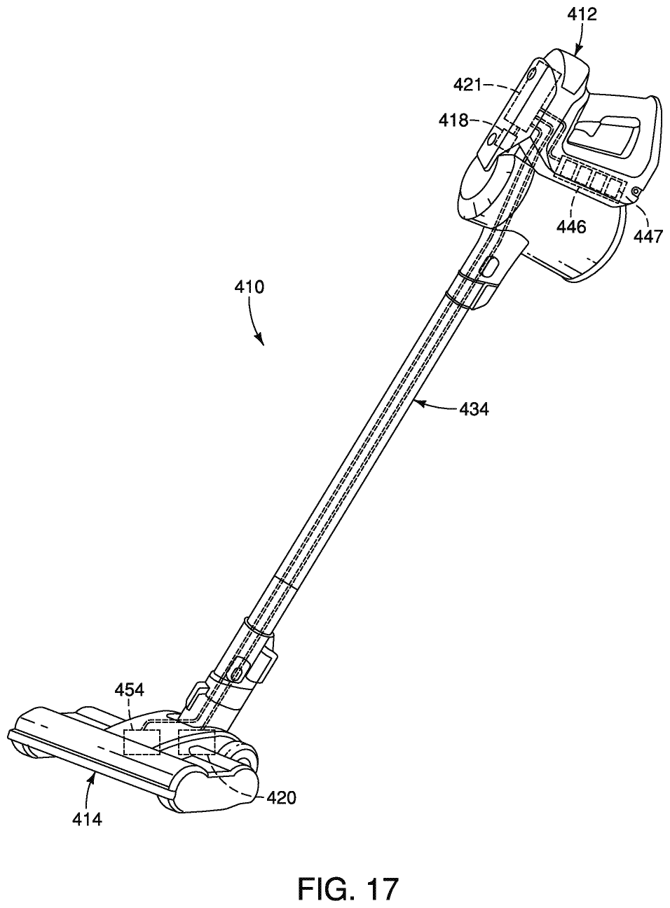

As shown in FIG. 17, a vacuum cleaner assembly 410 in accordance with another illustrated exemplary embodiment of the present invention is substantially similar to the vacuum cleaner assemblies 10 and 310 of the exemplary embodiment illustrated in FIGS. 1 to 6 and 10A to 16 except for the differences described below. Similar parts are identified with similar reference numerals, except increased by 400 (i.e., 4xx, accordingly).

The first power source 420 is connected to the accessory 414 instead of to the suction wand 334, as shown in FIG. 1 The operation of the first and second power sources 410 and 446 of the vacuum cleaner assembly 410 is substantially similar to the operation of the first and second power sources 310 and 346 of the vacuum cleaner assembly 310 illustrated in FIGS. 10A-16, The first power source 410 is connected to the accessory 414, such that when the suction wand 334 is removed and the accessory 314 is directly removably connected to the vacuum body 412, the electronic controller 421 controls the first power source 420 to supply power to the suction motor 418 and to the accessory motor 454. The electronic controller 421 controls the second power source 446 to supply power to the suction motor 418 and to the accessory motor 454 when the charge level of the first power source 420 falls below a predetermined charge level. When the accessory 314 including the first power source 420 is removed from the suction wand 434, the electronic controller 421 controls the second power source 446 to supply power to the suction motor 418.

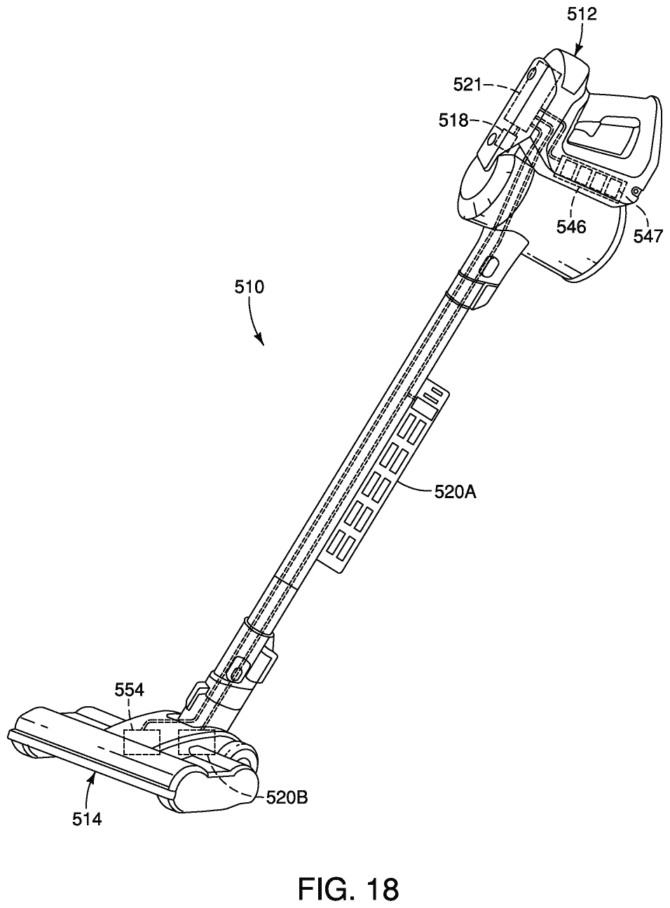

As shown in FIG. 18, a vacuum cleaner assembly 510 in accordance with another illustrated exemplary embodiment of the present invention is substantially similar to the vacuum cleaner assemblies 10 and 310 of the exemplary embodiment illustrated in FIGS. 1 to 6 and 10A to 16 except for the differences described below. Similar parts are identified with similar reference numerals, except increased by 500 (i.e., 5xx, accordingly).

The first power source includes a suction wand first power source 520A and an accessory first power source 520B. The suction wand first power source 520A and the accessory first power source 520B are bridged together, such that the operating time of the first power source is extended. The accessory first power source 520B is configured substantially similarly to the first power source 520A.

When the suction wand 534 and the accessory 514 including the accessory power source 520B are both connected to the vacuum body 512, the electronic controller 521 controls the suction wand first power source 520A and the accessory first power source 520B to supply power to the suction motor 518 and to the accessory motor 534. When only one of the suction wand first power source 520A and the accessory first power source 520B is electrically connected to the electronic controller 521, the electronic controller 521 controls the electrically connected first power source to supply power to the suction motor 518 and to the accessory 514 (when connected). Similarly to the vacuum cleaner assembly 310 of FIGS. 10A -- 16, when the charge level of the first power source falls below the predetermined level, the electronic controller 521 controls the second power source 546 to supply power to the suction motor 518 and to the accessory motor 554. When neither the suction wand first power source 520A nor the accessory first power source 520B is electrically connected to the electronic controller 521, the electronic controller 521 controls the second power source 546 to supply power to the suction motor 518.

The foregoing detailed description of the certain exemplary embodiments has been provided for the purpose of explaining the principles of the invention and its practical application, thereby enabling others skilled in the art to understand the invention for various exemplary embodiments and with various modifications as are suited to the particular use contemplated. This description is not necessarily intended to be exhaustive or to limit the invention to the exemplary embodiments disclosed. Any of the exemplary embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”. “rear”, “up”, “down”, “above”, “upper”, “below”, “lower”, “upward”, “upwardly”, “downward”, “downwardly”, “top”, “bottom”, “side”, “vertical”, “horizontal”, “perpendicular” and “transverse” as well as any other similar directional terms refer to those directions of a vacuum cleaner assembly in an upright position for use. Accordingly, these directional terms, as utilized to describe the vacuum cleaner assembly should be interpreted relative to a vacuum cleaner in an upright position on a horizontal surface. The terms “left” and “right” are used to indicate the “right” when referencing from the right side as viewed from the rear of the vacuum cleaner assembly, and the “left” when referencing from the left side as viewed from the rear of the vacuum cleaner assembly.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to he present in a particular embodiment at the same time. Every feature which is unique from the prior art, alone or in combination with other features, also should he considered a separate description of further inventions by the applicant, including the structural and/or functional concepts embodied by such feature(s). Thus, the foregoing descriptions of the exemplary embodiments according to the present invention are provided for illustration only, and not for the purpose of limiting the invention as defined by the appended claims and their equivalents.

1. A vacuum cleaner assembly, comprising:
a vacuum body;
a suction wand removably connected to the vacuum body;
an accessory removably connected to the suction wand;
a suction motor disposed in the vacuum body and configured to create flow through a suction path;
an accessory motor disposed in the accessory;
a first power source; and
a second power source;
the first power source being configured to supply power to the suction motor and to the accessory motor, the second power source being configured to supply power to the suction motor and to the accessory motor when the first power source falls below a predetermined charge level, the predetermined charge level being a non-zero charge level.

2. The vacuum cleaner assembly according to claim 1, wherein
each of the first and second power sources is a battery pack including a plurality of rechargeable battery cells.

3. The vacuum cleaner assembly according to claim 1, wherein
the second power source is configured to supply power to the suction motor when the suction wand is removed from the vacuum body.

4. The vacuum cleaner assembly according to claim 1, wherein
the second power source is configured to supply power to the suction motor and to the accessory motor when the accessory is connected to the vacuum body without the suction wand disposed therebetween.

5. The vacuum cleaner assembly according to claim 1, wherein
the first power source includes a first plurality of battery cells connected in series.

6. The vacuum cleaner assembly according to claim 5, wherein
the first power source includes a second plurality of battery cells connected in series, each of the battery cells of the second plurality of battery cells being connected in parallel to one of the battery cells of the first plurality of battery cells.

7. The vacuum cleaner assembly according to claim 1, wherein
the second power source includes a plurality of battery cells connected in series.

8. The vacuum cleaner assembly according to claim 1, wherein
a maximum voltage output of the first power source is larger than a maximum voltage output of the second power source.

9. The vacuum cleaner assembly according to claim 8, wherein
the suction motor is operable in first and second power settings, the second power setting operating at a larger voltage than the first power setting, and
the maximum voltage output of the second power source is less than the voltage of the first second power setting.

10. The vacuum cleaner assembly according to claim 1, wherein
the first power source is connected to an outer surface of the suction wand.

11. The vacuum cleaner assembly according to claim 1, wherein
the second power sources is disposed in the vacuum body.

12. The vacuum cleaner assembly according to claim 1, wherein
the first power source is connected to the accessory.

13. A vacuum cleaner assembly, comprising:
a vacuum body;
a suction wand removably connected to the vacuum body;
an accessory removably connected to the suction wand, the accessory being configured to be directly connected to the vacuum body when the suction wand is detached from the vacuum body;
a suction motor disposed in the vacuum body and configured to create flow through a suction path;
an accessory motor disposed in the accessory;
an electronic controller disposed in the vacuum body;
a first power source connected to an outer surface of the suction wand or disposed in the accessory, the first power source being electrically connected to the electronic controller; and
a second power source disposed in the vacuum body and electrically connected to the electronic controller;
the electronic controller being configured to supply power to the suction motor and to the accessory motor from the first power source, the electronic controller being configured to supply power to the suction motor and to the accessory motor from the second power source when the first power source falls below a predetermined charge level, the predetermined charge level being a non-zero charge level.

14. The vacuum cleaner assembly according to claim 13, wherein
each of the first and second power sources is a battery pack including a plurality of rechargeable battery cells.

15. The vacuum cleaner assembly according to claim 13, wherein
the second power source is configured to supply power to the suction motor when the suction wand is removed from the vacuum body.

16. The vacuum cleaner assembly according to claim 13, wherein
the second power source is configured to supply power to the suction motor and to the accessory motor when the accessory is connected to the vacuum body without the suction wand disposed therebetween.

17. The vacuum cleaner assembly according to claim 13, wherein
the first power source includes a first plurality of battery cells connected in series.

18. The vacuum cleaner assembly according to claim 17, wherein the first power source includes a second plurality of battery cells connected in series, each of the battery cells of the second plurality of battery cells being connected in parallel to one of the battery cells of the first plurality of battery cells.

19. The vacuum cleaner assembly according to claim 15, wherein
the suction motor is operable in first and second power settings, the first power setting operating at a larger voltage than the second power setting, and
a maximum voltage output of the second power source is less than the voltage of the first power setting.

20. The vacuum cleaner assembly according to claim 13, wherein
a maximum voltage output of the second power source is less than a maximum voltage output of the first power source.
